(19) United States
(12) Patent Application Publication
(10) Pub. No.: US 2005/0052030 A1
(43) Pub. Date: Mar. 10, 2005

(54) Roadside electrical power source

(76) Inventor: Charles G. Patrick, Millstone, NJ (US)

Correspondence Address: CHARLES G. PATRICK, 23 AMWELL RD., MILLSTONE, NJ, 08844, US

(21) Appl. No.: 10/672,709

(22) Filed: Sep. 8, 2003

(51) Int. Cl. H02P 9/04; F03B 13/10

(52) U.S. Cl. 290/44

(57) ABSTRACT

Instead of huge dams, nuclear power plants, wind mills, coal burning furnaces, and burning oil and gas to produce electricity, there is another method. The power that can be provided by the forward motion and weight of vehicular traffic. No cost, no waste, no great distances from point of access to customer. This is available wherever there is substantial highway traffic. Simple mechanical mechanisms can be invented to utilize the power of the massive highway traffic which continuously fills the highways of the modern world.

### DESCRIPTION OF PRIOR ARTS

Describing prior art seems unnecessary for this invention because the prior arts have existed for centuries, and the use of mechanical devises to produce electricity are generally known throughout the world. This invention does not change prior art; it only changes the source of work power that is used to create electricity.

The use of water power, wind, nuclear energy and fossil fuels are generally the normal means for the production of electrical energy. This invention adds one more source of available power to create electricity. The source is competitive for amounts of electricity produced—it is free, clean, does not produce waste products, and is generally available anywhere in a modern civilization. The invention can be placed in any local place where there would be a constant supply of highway traffic.

The source of this workforce is the movement and weight of vehicular traffic as it passes over a trip plate imbedded in a roadway where there is an abundant amount of traffic.

The trip plate, later described, activates underground machinery which turns a turbine, producing electricity.

Presently there are no devises that produce electricity using vehicular traffic as outlined in this invention summary.

What clearly shows in today's art of producing electricity is a need for a different supply of energy that is less costly, more convenient to deliver, safer, and cleaner than what is presently used. Today's supply of electrical energy is limited by the amount of fossil fuel supply (i.e. oil, coal, gas and coke), and water, wind, and nuclear power stations.

This invention provides the kind of working force necessary to overcome the tremendous torque which is needed to turn the huge turbines of modern civilization. The movement and weight of vehicular traffic provides, by individual measure, tons of pressure to overcome the torque of gigantic turbines.

### BACKGROUND OF THIS INVENTION

### Description of Related Art

The forces of flowing water, the super pressure of steam, the force of wind on propellers—each of these offer a background for this invention, and each of these forces turn or rotate an appliance that produces electrical current.

In order to produce large quantities of electricity, the constant flow of high quantities of water must flow thru dams or over waterfalls, and these are not to be found just anywhere.

Nuclear power plants do not offer complete safety and produce nuclear waste which must be safely disposed of, which is expensive.

Fossil fuels must be burned, produces fumes, and other toxic waste products. In addition, fossil fuels are not free.

Fossil fuels are expensive, dams are prone to the water level of rivers and of course, wind machines are susceptible to the prevailing wind forces and can be placed only in certain places.

This invention can be placed anywhere where traffic is abundant. Such as on busy city streets, state highways or federal highways. There can be a number of units each of which can be separate or in a series, in order to increase production.

Cost is minimal, especially when compared to a dam, or a nuclear power plants.

Cities, states, and federal governments can charge taxes on the use of streets and highways, and receive money from the use of its power by individuals. Manufacturing plants can settle along major highways and install private electrical plants using this invention. Users will find electric power to be relatively free and in constant supply.

### A BRIEF SUMMARY OF THIS INVENTION

The quantity of electric power produced is dependent on the amount of the traffic available, the size of the dynamo, and the number of units in place which are connected to each other. Other factors of quantity would be made evident as the invention becomes manifest while operational.

It is evident from the disclosure of the embodiment and the mechanical motion described herein that there are other possibilities to be discovered in future embodiments and mechanical actions by persons knowledgeable in this field.

### DESCRIPTION OF THE INVENTION

### Production of Power

This invention will produce electricity by transferring the movement and weight of a vehicle as it passes over a trip plates (TP.) The TP, by its action, further transfers this force to underground machinery, which turns a turbine. The turbine produces the electricity. The movement and weight of the vehicle provides the means to produce the electricity, i.e. to turn the turbine.

### Embodiment

The simplest way to describe the overall embodiment of this invention is to refer to a box within a box with a see-saw on top. The see-saw is the trip plate. The see-saw would run the length of the T.P. plus both the vault and the Main Housing. The outer box is placed perpendicular to the highway. The outer box is called a vault and is made of reinforced concrete. The inner box contains the machinery. The outer box protects the inner box and contains only a sump pump. The inner box is called the main housing. The only protruding part from the inner and outer boxes is the extension of the crankshaft leading to the turbine. When separated, the Main Housing can be removed for maintenance.

The dimensions of the outer box are 16′×8′×6′ and the thickness of the walls are 10″. The inner box measurements are 14′×7′×5′. The inner box is made of stainless steel. The four sides, top and bottom are bolted together. The top of the inner box is surrounded by a skirt of 2″ steel that fits over the 4 sides like the top of a shoe box. The top has a rectangular section cut out of it to house the T.P.

The measurement of the inner box is 10′×6′ and the walls are made of 3″ to 4″ thick steel. The T.P. is designed to act like a see-saw resembling an angle iron not bent to 90°, but rather to 120°. Its bend area would become the hinge section that would have a bar passing through its entire length, like a piano hinge.

The T.P. would be seated into the top rectangular section of the main housing so that the central hinged area would be flat with the surface of the road.

When one side of the T.P. lays flat on the surface of the road, the other side is up and open (by 3″±.) The T.P. activates the below ground machinery when it is rolled over by oncoming traffic.

The activity initiated by the T.P. is due to the attachments on its underbody; these are, the drive rods, and springs which are aligned along the length of the T.P. The rods are attached by swivel bearings, the springs are suitably attached. There are springs on both sides of the T.P. They are the front springs, attached to the front of the T.P., and the rear springs, attached the rear of the T.P.

Also located in the Main Housing MH, is the crankshaft, similar to most crankshafts with crank bearings at necessary angles which, when pushed and pulled by the drive rods would cause the entire shaft to turn.

Separated by a large flywheel, two drive rods would be attached each to a crankshaft bearing of its own.

With the flywheel between the rods, the ensemble would resemble the petals and sprocked of a bicycle. Two drive rods and a flywheel are considered a group. There are six groups each attached to a crankshaft bearing at 45° intervals. One set of rods will be pushing the crankshaft while the other group will be pulling, thus insuring a full cycle rotation of the shaft.

There are two types of springs. One type is open and can be closed only by compressing with 300 pounds of push pressure. The second type is closed and can be opened by applying 300 pounds of pull pressure. They are called the push and pull springs.

The bottom of the open springs fit into a receptacle built into the main housing, where they are suitably attached. The closed spring is attached to a part of the main housing and the underbody of the T.P. and is pulled to open by the upward movement of the T.P.

### Action

The action of the embodiment of the invention begins with the front wheels of the on coming vehicle. Both front and rear wheels are a part of the action.

Also, the T.P. is the essential action figure of the invention. Remember, the T.P. is designed as a see-saw, so that when one side is down flat with the road surface, the other side is up, about 3″±from the road.

The front faces the oncoming traffic; I will refer to it as the front side and to all the springs and rods as front springs and rods, and to the springs and rods on the opposite side as the rears springs and rods.

The initial action happens when the front wheels of the oncoming vehicle pass over the T.P. then onto the rear of the T.P., thus changing the position of the T.P. from front down to rear down. This action compresses the rear springs, while extending the front springs. Both actions are simultaneous. Also, the rear drive rods, attached to the crankshaft, drive the crankshaft, turning the flywheel and the turbine.

When the front wheels of the auto pass beyond the rear T.P., the rear springs are released, lifting the rear T.P. to its first position, open mouthed by 3″±where it awaits the oncoming rears wheel of the vehicle.

### Action (Rods)

The passage of the rear wheels of the auto unto the front section of the T.P. again begins the movement of the mechanism.

The drive rods will be referred to as D.R. The front D.R. is connected to the front T.P. and the rear D.R. to the rear T.P.

When the vehicle rolls over the front T.P., and the front T.P. is flat with the surface of the highway, two things are happening. 1.) The front springs are compressed and 2) The front D.R. is pushing the crank bearing to move.

When the auto passes over the front T.P. unto the rear T.P., the front spring is released and pulls the front T.P. down and the rear spring is compressed.

Also, the rear D.R. drives the crank bearing to which it is connected, through half its motion.

The front D.R. will then pull its bearing and the crankshaft will make one revolution. This action turns the flywheel which is between the drive rods. The total action turns the turbine which produces electricity.

As mentioned before, there are six groups of springs, rods and flywheels in the length of the T.P.

### Lube and Maintenance

Lubrication is achieved by filling the Main Housing to a specific level with oil, splash pans are placed in certain localities that would properly lubricate all the necessary parts.

Because of the splashing of oil unto the bottom of the T.P., there is a chance that oil would spill to the outside of the Main Housing. Therefore, it is necessary to place a cover over the T.P. and the Main Housing, made of a suitable material not only to block the splashing oil, but also to keep out rain, snow and highway debris.

### Quantity of Production

The quantity of electric power which can be produced by this invention can be increased by adding additional units on the opposite side of the road or/and additional units in other lanes.

1. I claim as invention, a surface and underground mechanism to turn a turbine to create electricity. This invention includes mechanism triggered into action by a highway surface devise which causes it to apply the surface action of motor vehicle traffic weight and motion to said underground mechanism.
